(19) United States
(12) Patent Application Publication
(10) Pub. No.: US 2012/0083918 A1
(43) Pub. Date: Apr. 5, 2012

(54) SEALED CONTAINER AND SEMICONDUCTOR MANUFACTURING APPARATUS

(76) Inventor: Katsuhiro Yamazaki, Yokohama-shi (JP)

(21) Appl. No.: 13/247,740

(22) Filed: Sep. 28, 2011

(30) Foreign Application Priority Data
Sep. 30, 2010 (JP) 2010-222949
Aug. 23, 2011 (JP) 2011-181838

(51) Int. Cl. G06F 19/00; B65D 85/86

(52) U.S. Cl. 700/112; 206/710

(57) ABSTRACT

A semiconductor manufacturing apparatus 1 includes a wafer 10, a FOUP 20 that is a sealed container retaining the wafer 10 therein, an etching apparatus 30 that is a semiconductor processing apparatus, and an EFEM 40 that carries the wafer in a sealed condition between the FOUP and the etching apparatus. The FOUP includes a front door 20a, a sensor unit 21b detecting at least one of a temperature, a humidity, and a gas concentration, and a transmitter 25 that transmits information detected by the sensor unit. A receiver 31 receives information from the transmitter, and supplies the information to a purging unit 43. The purging unit performs purging until the temperature, etc., in the FOUP satisfies a reference value set beforehand.

### CROSS-REFERENCE TO RELATED APPLICATIONS

This application is based upon and claims the benefit of priority from Japanese Patent Application No. 2010-222949 filed on Sep. 30, 2010 and Japanese Patent Application No. 2011-181838 filed on Aug. 23, 2011; the entire contents all of which are incorporated herein by reference.

### TECHNICAL FIELD

The present invention relates to a sealed container that is used for retaining and carrying a semiconductor substrate like a wafer, and a semiconductor manufacturing apparatus including such a container.

### BACKGROUND ART

A following technical issue is involved throughout the process of the conventional semiconductor processing apparatuses. That is, product materials and adsorptive materials containing, for example, halogen atoms are left on a process target like a wafer, and react with moisture in the atmosphere outside a vacuum processing chamber, so that tiny particles and defects are produced.

In the case of semiconductors with a remarkable development of scale-down, such tiny foreign materials largely affect the yield of semiconductor devices. In order to eliminate such tiny foreign materials, for example, the product materials and adsorptive materials containing halogen atoms are eliminated from a semiconductor substrate after the process. In order to do so, however, equipment like a heating mechanism and a rinsing mechanism for the process target are necessary.

For example, JP 2006-12940 A discloses a technology of converting halogen-based silicon deposited on a wafer having undergone a process, C12 and HBr, etc., physically adsorbed on the wafer into halogenated ammonium. Since halogenated ammonium is a soluble material, such a material can be easily eliminated through a wet cleaning process.

JP 05-36618 A discloses a technology of keeping an inactive gas flowing into a vacuum load lock chamber where a wafer passes through when carried to a processing chamber. According to this technology, it is possible to suppress the electrostatic charging when the wafer is carried to the processing chamber from the vacuum load lock chamber as well as the growth of natural oxide film when the wafer is carried from the processing chamber to the vacuum load lock chamber.

Conversely, JP 2009-158600 A discloses a technology of detecting the presence of a wafer mounted on slots in a cassette for carrying wafers by a sensor provided in the cassette. According to this technology, information from the sensor is stored in a memory unit, and the stored slot information is transmitted to the equipment outside the cassette.

### DISCLOSURE OF THE INVENTION

The technology disclosed in JP 2006-12940 A eliminates halogenated ammonium on a wafer through a wet cleaning process. The technology disclosed in JP 05-36618 A suppresses the growth of a natural oxide film by introducing the inactive gas into the vacuum load lock chamber. According to those technologies, however, when a wafer having undergone a process is retained in a retaining container, the temperature, the humidity, and the gas concentration, etc., in the container are not controlled. Hence, the technical problem of generating particles and defects originating from the atmosphere in the container is not solved.

Furthermore, the technology disclosed in JP 2009-158600 A provides the sensor in the cassette which transmits information wirelessly. However, the information transmitted is merely slot information indicating the presence of wafers. Therefore, environmental information like a temperature is note considered.

### SUMMARY OF THE INVENTION

It is an object of the present invention to suppress production of reactants originating from the atmosphere in a sealed container.

A sealed container and a semiconductor manufacturing apparatus according to the present invention are as follows:

(1) a sealed container used for retaining and carrying a semiconductor substrate, and the sealed container including: a sensor unit which is provided in an interior of a main body of the sealed container and which detects at least one of a temperature, a humidity and a gas concentration inside the sealed container; and an external output unit that outputs information detected by the sensor unit to an exterior.

(2) a semiconductor manufacturing apparatus including: the sealed container, of which the external output unit is a transmitter; a processing apparatus that processes the semiconductor substrate; a carrier apparatus which joins the sealed container and the processing apparatus together in a sealed condition and which carries the semiconductor substrate from the sealed container to the processing apparatus, the processing apparatus including: a receiver that receives information output by the transmitter; a memory unit that stores the received information; and an output unit that outputs the stored information, the carrier apparatus including a purging unit that adjusts an internal atmosphere of the sealed container, the purging unit being configured to purge a gas on a basis of information from the output unit until at least one of a temperature, a humidity, and a gas concentration inside the sealed container satisfies a reference value set beforehand.

According to the present invention, it becomes possible to suppress production of reactants originating from the atmosphere in a sealed container.

### BRIEF DESCRIPTION OF THE DRAWINGS

FIG. 1 is a side view showing a configuration of a semiconductor manufacturing apparatus according to an embodiment;

FIG. 2 is a functional block diagram showing a configuration of the semiconductor manufacturing apparatus according to the embodiment;

FIG. 3 is a plan view showing a purging-outputting unit according to the embodiment;

FIG. 4 is a flowchart showing an operation of the semiconductor manufacturing apparatus according to the embodiment; and

FIGS. 5A and 5B are perspective views showing a sealed container according to another embodiment.

### DETAILED DESCRIPTION OF THE EMBODIMENTS

### <Configuration>

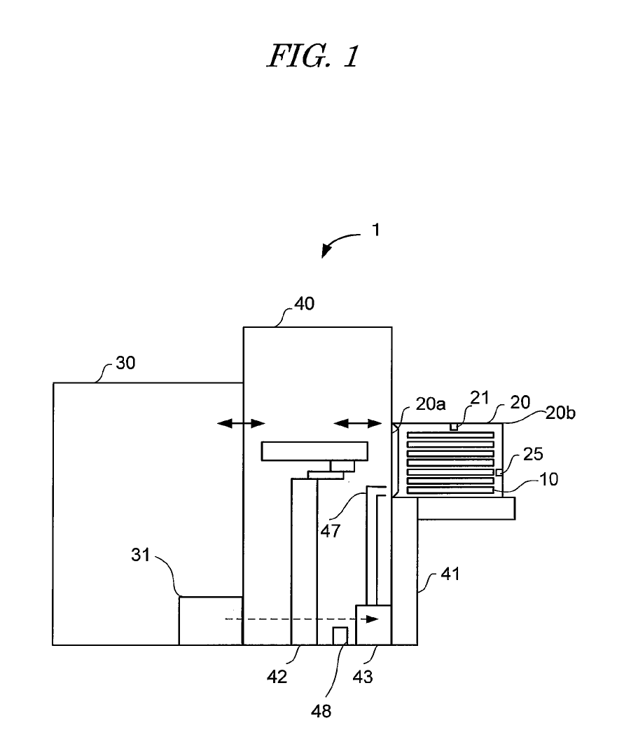

A semiconductor manufacturing apparatus 1 according to an embodiment and shown in FIG. 1 basically has following structural elements.

(1) A FOUP (Front Opening Unified Pod) 20 that is an illustrative example of the sealed container which retains one or plural wafers 10 that are process targets.

(2) An etching apparatus 30 that is an illustrative example of the processing apparatus of the wafer 10.

(3) An EFEM (Equipment Front End Module) 40 that is an illustrative example of the carrying apparatus that carries the wafer 10 in a sealed condition between the FOUP 20 and the etching apparatus 30.

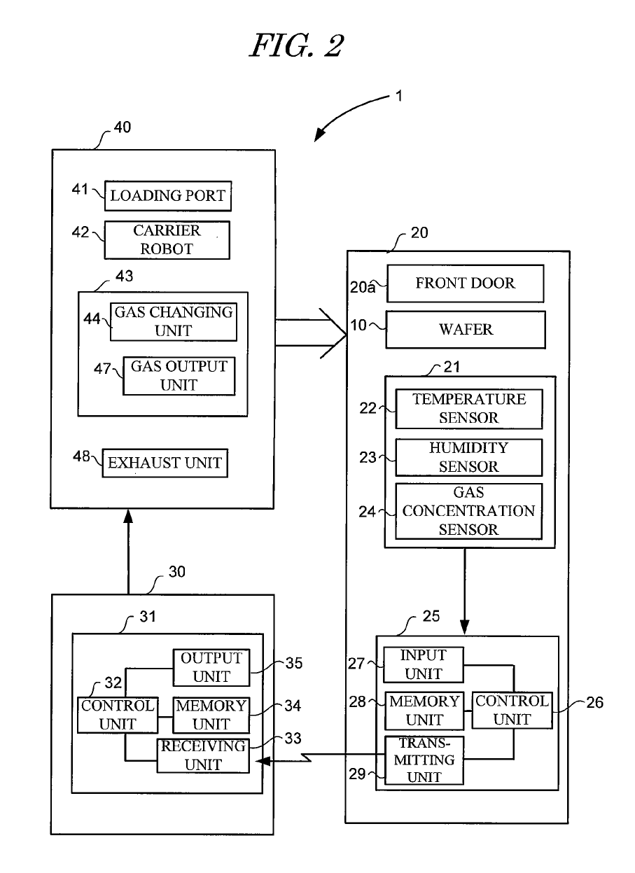

An explanation will now be given of a configuration of the semiconductor manufacturing apparatus 1 with reference to FIG. 2. The FOUP 20 is a 300-mm-wafer carrying container that conforms to the SEMI (Semiconductor Equipment and Materials International) standard, and carries the wafer 10 from a process to another process while maintaining the sealed condition. The FOUP 20 includes a front door 20a, a sensor unit 21, and a transmitter 25 that is an external output unit.

The sensor unit 21 includes a temperature sensor 22 like a thermocouple or IC temperature sensor or a radiation thermometer, a humidity sensor 23 like an IC humidity sensor, and a gas concentration sensor 24 all provided in a FOUP main body (a container main body) 20b. Respective pieces of information detected by respective sensors of the sensor unit 21 (e.g., information on a sensor measured value and the presence of an abnormality on the basis of the measured value) are supplied to the transmitter 25.

The sensor unit 21 can be provided in the FOUP main body (the container main body) at a location overlapping the area where the wafers retained in the FOUP main body are present in a planar view of the main body of the sealed container and above such a location in a direction (the vertical direction in FIG. 1) in which the wafers are held. This facilitates detection of a toxic gas produced from the surface of the wafer 10 having undergone a process when, in particular, a gas concentration is a target of detection. Since the toxic gas is lighter than air, it goes up from the surface of the wafer 10 after produced.

Moreover, the sensor unit 21 may not include all of the three sensors detecting a temperature, a humidity, and a gas concentration, but may include at least one of those sensors, and may detect at least one of the temperature, the humidity, and the gas concentration.

The transmitter 25 includes, as an example configuration, a control unit 26, an input unit 27, a memory unit 28, and a transmitting unit 29. The control unit 26 controls respective units of the transmitter 25. Respective pieces of information from the sensor unit 21 are input into the input unit 27. The memory unit 28 stores pieces of information input in the input unit 27. The transmitting unit 29 transmits information stored in the memory unit 28, i.e., information from the sensor unit 21 to the etching apparatus 30.

The etching apparatus 30 is, for example, a dry etching apparatus. The dry etching apparatus produces volatile compounds based on a chemical reaction of the activated atoms in low-temperature plasma with a sample with the aid of a reactive gas, and processes the wafer 10. The etching apparatus 30 includes a receiver 31 that receives information from the transmitter 25 of the FOUP 20.

The receiver 31 includes, as an example, a control unit 32, a receiving unit 33, a memory unit 34, and an output unit 35. The control unit 32 controls respective units of the receiver 31. The receiving unit 33 receives information (a measured value of each sensor) transmitted from the transmitting unit 29. The memory unit 34 stores information received by the receiving unit 33, compares the stored information with a reference value to be discussed later, and also stores a comparison result. The output unit 35 outputs information stored in the memory unit 34 to the EFEM 40. A communication between the transmitter 25 and the receiver 31 may be a wired or wireless communication. If the wireless communication is used, a connection through a wiring between those units can be eliminated, and thus botheration of wiring, incorrect wiring, and the cost of wires can be suppressed. Example wireless communication schemes are wireless LAN, high-speed PHS, CDMA, W-CDMA, and infrared.

The EFEM 40 is connected to both FOUP 20 and etching apparatus 30 in a sealed manner, and handles the wafer 10 without exposing to the ambient air. The EFEM 40 includes a loading port 41 for opening/closing the FOUP 20, a carrier robot 42 that carries the wafer 10 between the FOUP 20 and the etching apparatus 30, a purging unit 43 for the EFEM 40, and an exhaust unit 48 of a purged gas.

More specifically, the loading port 41 is an interface on which the FOUP 20 is mounted and which is for carrying the wafer 10 into the EFEM 40. The carrier robot 42 is a clean robot that carries the wafer 10 retained in the FOUP 20 to the etching apparatus 30.

The purging unit 43 includes a gas changing unit 44 and gas outputting units 47. The gas changing unit 44 changes a gas output from the purging unit 43 among a temperature purging gas, a humidity purging gas, and a concentration purging gas, for example by using respective valves of respective pipings. The purging unit 43 also includes an unillustrated control unit that controls the gas changing unit 44 and the gas outputting unit 47 in accordance with an output by the output unit 35 of the receiver 31.

The temperature purging gas is introduced into the FOUP 20 and cools or heats the interior of the FOUP 20 in order to set the interior thereof to be an appropriate temperature. The humidity purging gas is a dried or moist gas introduced in the FOUP 20 in order to set the interior thereof to be an appropriate humidity. It is desirable that the humidity of the interior of the FOUP 20 should be lower than that of the external atmosphere in order to suppress production of product materials and reactants with moisture on the wafer 10. The concentration purging gas is Ar, N₂, etc., purged in the FOUP 20 in order to attenuate the concentration of a toxic gas.

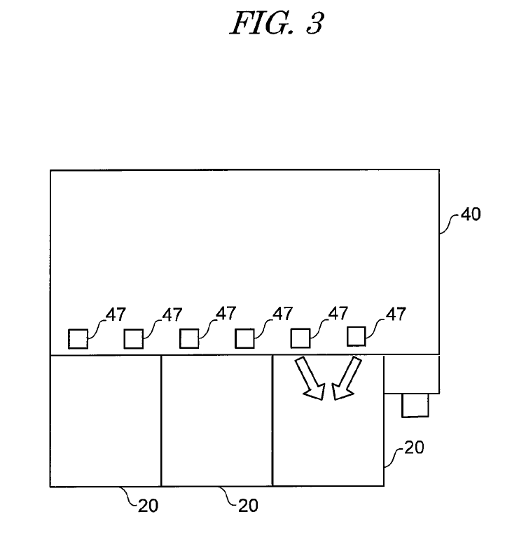

As shown in FIG. 3, the gas output units 47 purge a gas, for example from two locations, to the FOUP 20 having the front door opened. The exhaust unit 48 ejects the purged gas supplied in the FOUP 20 and the EFEM 40 following to the above-explained purging.

A gas-flow direction plate may be provided ahead of the gas output units 47 in order to adjust the direction of the gas flow, though not illustrated in the drawings. When a purging gas is intensely supplied toward the interior of the FOUP 20, the gas-flow direction plate is fixed toward the FOUP 20 so that the purging gas output by the gas output units 47 flows toward the interior of the FOUP 20. Moreover, when a purging gas is supplied to both FOUP 20 and EFEM 40, it is appropriate if the gas-flow direction plate is swingable.

In FIG. 1, the gas output unit 47 runs from the bottom of the EFEM 40, but the gas output unit 47 may be provided in the vicinity of the ceiling of the EFEM 40. In this case, since it is possible to provide the exhaust unit 48 at the bottom of the EFEM 40, a down-flow gas flow is formed, purging can be performed efficiently, and thus soaring of particles, etc., can be suppressed.

### <Operation>

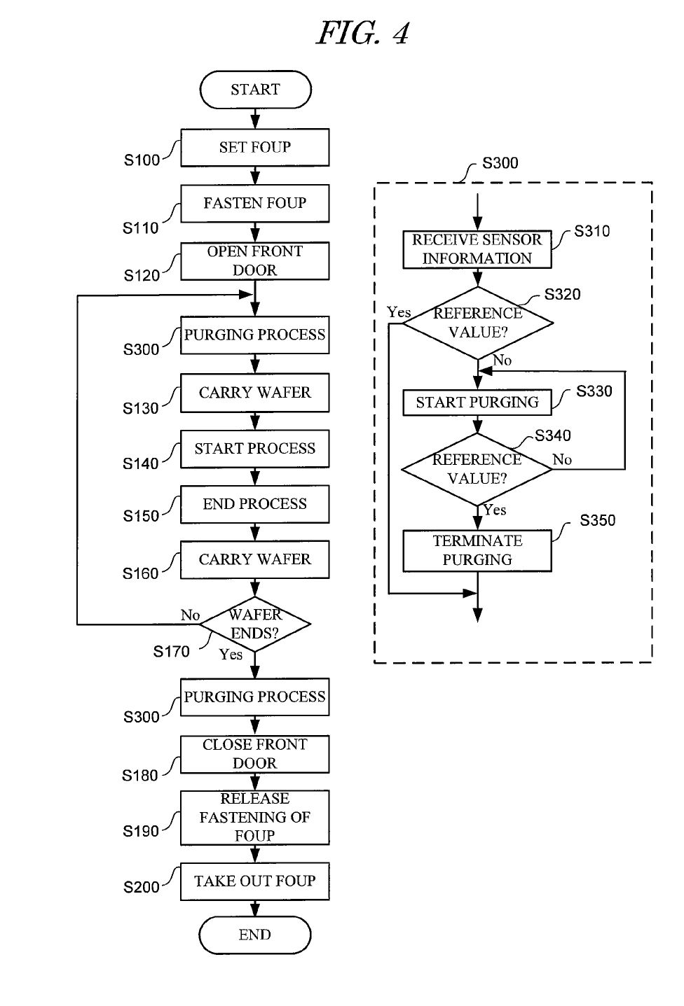

An explanation will be given of an operation according to the embodiment with reference to the flowchart of FIG. 4.

The FOUP 20 retains the wafer 10 in the sealed interior thereof and is carried by a robot, etc., between respective processes by the semiconductor manufacturing apparatus. At this time, the transmitter 25 is transmitting information like the temperature inside the FOUP 20 detected by the sensor unit 21 to the exterior. The term “exterior” in the embodiment means the receiver 31.

In order to allow the etching apparatus 30 to process the wafer 10 retained in the FOUP 20, the FOUP 20 is mounted on the loading port 41 and is fastened therewith (steps S100 and S110).

In order to carry the wafer 10 to the etching apparatus 30, the loading port 41 opens the front door 20a of the FOUP 20 (step S120). In this state, a purging process of the embodiment is performed (step S300).

The purging process (step S300) includes processes from step S310 to S350. These processes will be explained in detail below.

First, the receiver 31 at the etching-apparatus-30 side receives information on the atmosphere in the FOUP 20 from the transmitter 25 of the FOUP 20 (step S310).

These pieces of information received are compared with respective reference values stored in advance in, for example, the memory unit 34 (step S320). When those pieces of information satisfy the reference values (step S320: YES), the process is terminated without executing the purging process.

Conversely, when those pieces of information do not satisfy the reference values (step S320: NO), the purging unit 43 starts gas purging to one or plural wafers 10 in the FOUP 20 (step S330). That is, in accordance with information of the atmosphere in the FOUP 20 received by the receiver 31, the unillustrated control unit of the purging unit 43 selects a gas necessary for adjusting the atmosphere. The selection result is transmitted to the gas changing unit 44, and the gas changing unit 44 selects the necessary gas from a plurality of gas cylinders or gas pipings prepared beforehand, and supplies the selected gas to the interior of the FOUP 20 through the gas output units 47.

The temperature purging gas is, for example, an N₂ gas having a temperature adjusted by a heater or a cooler provided in the halfway of the piping. This gas is supplied to the interior of the FOUP 20 from the gas output unit 47 and heats or cools the interior of the FOUP 20 so that the temperature inside thereof satisfies the reference value. Likewise, the humidity purging gas is caused to pass through a humidifier or a dehumidifier provided in the halfway of the piping so that the humidity inside the FOUP 20 satisfies the reference value. By purging such a gas having undergone moisture adjustment in the FOUP 20, the humidity atmosphere in the FOUP 20 can be within the range of the reference value. The reference value for the humidity is preferably 5%. When, for example, the humidity detected by the sensor unit 21 is higher than 5%, dehumidification purging is performed until the humidity becomes equal to or lower than 5%, as will be explained in detail later.

The concentration purging gas is, for example, an N₂ gas and purged in the FOUP 20 from the gas output unit 47 in order to set the gas concentration in the FOUP 20 to be a certain value set beforehand. For example, in the case of POLY-Si doped with AS (arsenic) or P (phosphorous), when a process gas with an extremely high toxicity, such as AsH₃ (arsine) or PH₃ (phosphine), is used, a toxic gas component present within the film of the wafer 10 or on the film surface thereof is detached, and the toxic gas concentration in the FOUP 20 increases. Such a toxic gas has an allowable gas concentration level (TLV value). In the case of arsine, TLV value is 0.05 ppm, and is 0.3 ppm in the case of phosphine. It is appropriate to check whether or not the gas concentration is equal to or smaller than such values. By purging the gas like N₂ in the FOUP 20, the concentration of the toxic gas in the FOUP 20 can be attenuated and becomes within the range of the reference value.

Regarding such purging gases, plural kinds of gases may be prepared in advance and may be changed by the gas changing unit 44 when in use. Alternatively, a heater, a cooler, a dehumidifier, and a humidifier may be disposed in the halfway of a piping for one kind of gas, and may be activated depending on the required characteristic of the gas in order to obtain a necessary purging gas.

After the start of the gas purging, the temperature sensor 22, the humidity sensor 23, and the gas concentration sensor 24 at the FOUP 20 keep transmitting respective pieces of information from the transmitting unit 29 of the FOUP 20 to the receiving unit 33 of the etching apparatus 30. Those pieces of information received by the etching apparatus 30 are compared with respective reference values point by point stored in the memory unit 34 beforehand (step S340). The purging is continued until those pieces of information match respective reference values (step S340: NO), and when those pieces of information satisfy respective reference values (step S340: YES), the purging is terminated (step S350).

In this way, the gas purging completes before the carrying of the wafer 10 starts. Then, the carrier robot 42 takes out the wafer 10 from the FOUP 20, and carries the wafer 10 to the etching apparatus 30 through the interior of the EFEM 40 (step S130). The carried wafer 10 is processed by the etching apparatus 30 (step S140). When the etching process completes (step S150), the wafer 10 is carried by the carrier robot 42, and is retained in the FOUP 20 (step S160). If the wafer 10 not processed yet is left in the FOUP 20, the process is repeated on the remaining wafer 10. In this case, when the atmosphere in the FOUP 20 becomes a condition not satisfying the reference values, the purging process (step S300) is executed (step S170: NO).

When all wafers 10 retained in the FOUP 20 are processed (step S170: YES), the purging process is executed again (step S300). In this case, when the internal atmosphere of the FOUP 20 satisfies the reference values (step S320: YES), no purging process is executed. When the purging process completes, the loading port 41 closes the front door 20a of the FOUP 20, and releases the fastening of the FOUP 20 (steps S180 and S190). Thereafter, the FOUP 20 is taken out from the loading port 41, and is carried to the next process by a robot, etc. (step S200).

### Effect of the Embodiment

The semiconductor manufacturing apparatus 1 and the FOUP 20 according to the embodiment have following effects.

(1) The semiconductor manufacturing apparatus 1 is capable of measuring a temperature, a humidity and a gas concentration in the FOUP 20 through the sensor unit 21, and of transmitting those pieces of measured information to the receiver 31 from the transmitter 25. Accordingly, the atmosphere in the FOUP 20 can be monitored and an abnormality can be detected by a simple configuration. Moreover, since the atmosphere in the FOUP 20 is directly measured by the sensor unit 21, the abnormality of the atmosphere can be detected in a real-time manner. Furthermore, since dry purging or N₂ purging by the purging unit 43 is performed until the internal atmosphere of the FOUP 20 becomes normal, production of reactants originating from the atmosphere in the sealed container can be suppressed.

(2) Since the semiconductor manufacturing apparatus 1 can suppress production of reactants on the wafer 10 because of the above-explained reason, the productivity of the wafers 10, i.e., the yield thereof can be improved.

(3) When carried between respective processes by the semiconductor manufacturing apparatus 1, the FOUP can supply environmental information like an internal temperature to the exterior through the transmitter 25. Accordingly, information on an abnormality, etc., can be supplied in a real-time manner.

### Other Embodiments

The present invention is not limited to the above-explained embodiment, and includes following other embodiments.

(1) The processing apparatus in the above-explained embodiment is the etching apparatus 30 that is a semiconductor manufacturing apparatus, but the present invention is not limited to such an apparatus. For example, the processing apparatus may be a processing apparatus for a liquid crystal or an MD.

(2) The process target in the above-explained embodiment is the wafer 10 that is a semiconductor substrate, but the present invention is not limited to the semiconductor substrate. For example, the process target may be a liquid crystal substrate or an MD substrate.

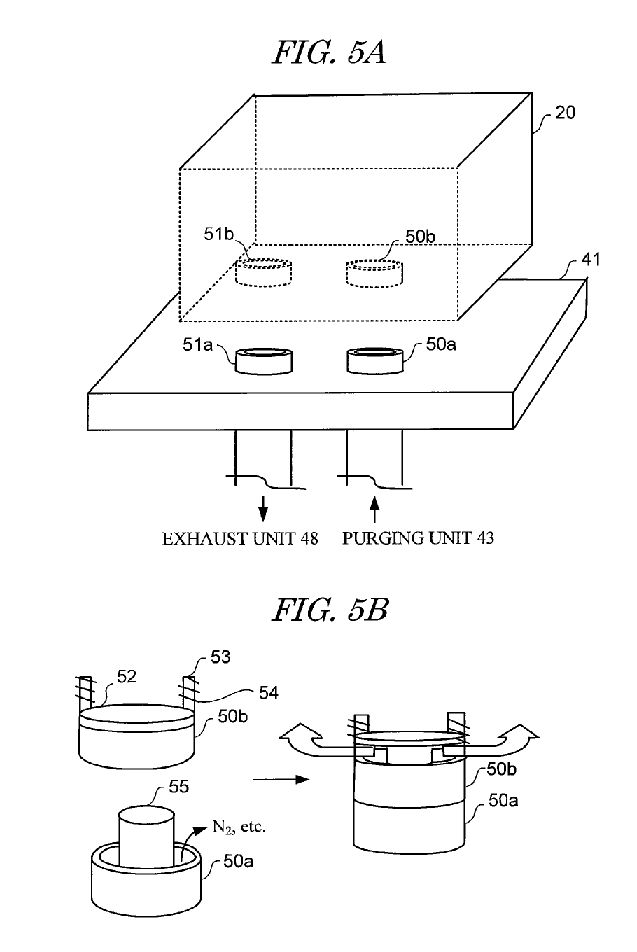

(3) In the embodiment shown in FIGS. 1 and 2, a gas is purged from the two locations to the interior of the FOUP 20 with the front door 20a being opened, but the present invention is not limited to this configuration. For example, a configuration shown in FIGS. 5A and 5B may be employed. According to this another embodiment, as shown in FIG. 5A, with the front door 20a (see FIG. 1) being closed, a purge gas from the purging unit 43 is charged in the FOUP 20 through a gas charging portion 50a provided at the loading port 41 and a gas charging portion 50b formed in the FOUP main body 20b. The gas charged in the FOUP 20 is ejected to the exhaust unit 48 through a degassing portion 51a provided at the loading port 41 and a degassing portion 51b formed in the FOUP main body 20b. Moreover, in FIG. 5A, although the gas charging portion 50a is connected to the bottom of the FOUP main body 20b, the gas charging portion 50b may be provided at the ceiling of the FOUP main body 20b. The gas charging portion 50a may be provided at the loading port 41 so as to oppose the gas charging portion 50b. In this case, as shown in FIG. 5A, if the degassing portion 51b is provided at the bottom of the FOUP 20, a downward gas flow is formed in the FOUP 20, making the purging effective and suppressing soaring of particles.

FIG. 5B shows conditions of the gas charging portions 50a and 50b before and after coupling. As shown in FIG. 5B, the gas charging portion 50b includes a sealing lid 52 for sealing the interior of the FOUP 20, sealing-lid guides 53 that guide the sealing lid 52 so as to move in the vertical direction, and coil springs 54 that push down the sealing lid 52. The gas charging unit 50a includes a plug 55 that pushes up the sealing lid 52. When the gas charging portions 50a and 50b are coupled together, the plug 55 pushes up the sealing lid 52, and a purging gas like N₂ is charged in the FOUP 20.

(4) In the embodiment shown in FIGS. 1 and 2, although the etching apparatus 30 includes the receiver 31, the present invention is not limited to this configuration. For example, the loading port 41 on which the FOUP 20 is mounted may include the receiver 31 that communicates with the transmitter 25.

(5) The purging process in the above-explained embodiment is not executed while the wafer 10 is being processed, but the present invention is not limited to this configuration. For example, during the process, if another wafer 10 is retained in the FOUP 20, the purging process may be executed. The flowchart of FIG. 4 is an example, and the atmosphere in the FOUP 20 can be adjusted regardless of the process performed on the wafer 10.

(6) In the above-explained embodiment, the transmitting unit 29 and the receiving unit 33 that communicate with each other information detected by the sensor unit 21 are used, but the present invention may omit those units. For example, the FOUP main body 20b may have a display unit like a monitor as an external output unit that displays information from the sensor unit 21. By this configuration, the atmosphere condition in the FOUP 20 can be notified to the exterior through the display unit. Accordingly, an operator can watch the display unit in order to activate the purging unit 43 as needed, and the purging process in the FOUP 20 can be performed. This also makes it possible to suppress production of reactants originating from the atmosphere inside the sealed container.

(7) According to the purging process of the above-explained embodiment, all of the temperature, humidity, and gas concentration inside the FOUP 20 are controlled to satisfy respective reference values. However, in more detail, it is also possible to perform the purging so as to satisfy one of the reference values first and then satisfy the remaining conditions. For example, a toxic gas like arsine immediately causes a chemical reaction when bonded with moisture left in the FOUP 20, and a large negative effect may possibly act on the semiconductor substrate. Accordingly, the concentration purging is performed at first to decrease the toxic gas concentration and the temperature and the humidity are then adjusted, therefore a negative effect by the chemical reaction can be reduced.

(8) In the above-explained embodiment, the FOUP is used as an example of the sealed container, but the present invention is not limited to any particular one as long as it can retain a semiconductor substrate regardless of a shape and a size. For example, the present invention can be applied to containers, such as so-called carrier, cassette, pod, and stocker.

1. A sealed container used for retaining and carrying a semiconductor substrate, the sealed container comprising:
a sensor unit which is provided in an interior of a main body of the sealed container and which detects at least one of a temperature, a humidity and a gas concentration inside the sealed container; and
an external output unit that outputs information detected by the sensor unit to an exterior.

2. The sealed container according to claim 1, wherein the external output unit is a transmitter.

3. The sealed container according to claim 1, wherein the external output unit is a display unit including a monitor provided on the main body of the sealed container.

4. The sealed container according to claim 1, wherein the sensor unit is provided at a location overlapping an area where the semiconductor substrate retained in the main body of the sealed container is present in a planar view of the main body of the sealed container and above that location in a direction in which semiconductor substrate is held.

5. The sealed container according to claim 1, wherein the main body of the sealed container is provided with a gas charging portion where a purging gas is charged based on information from the sensor unit.

6. The sealed container according to claim 5, wherein the gas charging portion is provided at a ceiling of the main body of the sealed container.

7. The sealed container according to claim 5, wherein the main body of the sealed container is provided with a degassing portion where the purged gas is ejected.

8. A semiconductor manufacturing apparatus comprising:
the sealed container according to claim 2;
a processing apparatus that processes the semiconductor substrate;
a carrier apparatus which joins the sealed container and the processing apparatus together in a sealed condition and which carries the semiconductor substrate from the sealed container to the processing apparatus,
the processing apparatus comprising:
a receiver that receives information output by the transmitter;
a memory unit that stores the received information; and
an output unit that outputs the stored information,
the carrier apparatus comprising a purging unit that adjusts an internal atmosphere of the sealed container,
the purging unit being configured to purge a gas on a basis of information from the output unit until at least one of a temperature, a humidity, and a gas concentration inside the sealed container satisfies a reference value set beforehand.
